(19) United States
(12) Patent Application Publication
(10) Pub. No.: US 2005/0141028 A1
(43) Pub. Date: Jun. 30, 2005

(54) Document management system for automating operations performed on documents in data storage areas

(75) Inventor: George Koppich, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Toshiba Corporation and Toshiba Tec Kabushiki Kaisha

(21) Appl. No.: 11/064,478

(22) Filed: Feb. 23, 2005

Related U.S. Application Data
(63) Continuation-in-part of application No. 10/125,856, filed on Apr. 19, 2002.
(63) Continuation-in-part of application No. 10/269,648, filed on Oct. 10, 2002.

(51) Int. Cl. G06F 15/00

(52) U.S. Cl. 358/1.15; 358/400

(57) ABSTRACT

This invention is related to document management systems, and more particularly, to a document management system for automating selected operations to be performed on at least one document in a data storage area. The invention is directed to a method and system for automatically performing preselected operations on electronic documents. The method and system comprising the steps of and means adapted for receiving at least one electronic document into a data storage area accessible by a plurality of users; associating at least one preselected operation with the data storage area, such that such preselected operation is performed automatically by any document received into the data storage area; and performing the preselected operation on each electronic document received into the data storage area.

This application is a continuation-in-part of pending U.S. patent application Ser. No. 10/125,856 filed Apr. 19, 2002, and a continuation-in-part of pending U.S. patent application Ser. No. 10/269,648 filed Oct. 10, 2002, the entireties of which are hereby incorporated by reference.

### BACKGROUND OF THE INVENTION

This invention is related to document management systems, and more particularly, to a document management system for automating selected operations to be performed on electronic documents which are retrieved based on selected search criteria and received into a document data storage area.

There is tremendous value in ensuring that information, whether in structured or unstructured formats is captured, managed, and used in an effective and efficient way. Document management systems allow users to create centralized repositories, or libraries, containing all of the unstructured data they generate, such as information stored in text files, emails, documents, multimedia, etc. Powerful search and retrieval tools make this information easily available for use and collaboration across the entire enterprise. These tools often provide security and version control capabilities.

Document management systems also provide a means for freeing up storage space and reducing the costs of paper document copying and distribution. They often provide multiple methods of adding documents and indexing information to the document management system while facilitating easy revisions, creation of new versions, annotation, and document sharing. One of the most important aspects of document management systems is their ability to eliminate time-consuming physical searches for misfiled or lost documents. Some document management systems allow users to save various types of documents in a single location (i.e. related client emails and Word documents in the same folder). Furthermore, they provide users with an ability to back up all essential business documents, both scanned and computer-generated, and may integrate optical character recognition technology so that full text searches may be performed on scanned documents.

In addition, a benefit of document management systems is that they facilitate collaboration. One such method is providing document distribution functionality so that one user may easily share documents with or send documents to other users, devices or systems. Unfortunately, the document distribution functionality of document management systems generally calls for a user to manually select an appropriate distribution function for each document in the document management system. This is a tedious and time consuming task. It would be preferable, however, if document distribution functionality provided users with the ability for automating selected operations to be performed on a plurality of documents in a data storage area. It would also be preferable if a user were able to perform a search for all documents on which the user desires to perform selected operations and the user were then able to perform such selected operations on the documents retrieved.

### SUMMARY OF THE INVENTION

In accordance with the present invention, there is provided a document management system with an improved document distribution functionality.

Further, in accordance with the present invention, there is provided a document management system which provides a user with the ability for automating selected operations to be performed on at least one document in a data storage area.

Further, in accordance with the present invention, there is provided a document management system which provides a user with the ability to perform a search for all documents on which the user desires to perform selected operations and the user were then able to perform such selected operations on the documents retrieved.

Still further, in accordance with the present invention, there is provided a method for automatically performing preselected operations on electronic documents satisfying selected search criteria. The method comprises the steps of associating at least one preselected operation with a document data storage area, such that such preselected operation is performed automatically by any electronic document received into the data storage area and receiving data representative of selected search criteria associated with electronic documents. The method also comprises the steps of performing a search of the electronic documents in accordance with the search criteria, wherein the electronic documents obtained from the search are received in the document data storage area and performing the preselected operation on each electronic document received into the document data storage area.

In a preferred embodiment, the selected search criteria include at least one of keywords, indices, electronic document size, electronic document creation date, electronic document name, electronic document content, and electronic document creator name. Preferably, the step of receiving data representative of selected search criteria comprises the steps of prompting an associated user for information about the search criteria and receiving from the associated user selection data representative of the search criteria after the completion of the step of prompting the user.

In a preferred embodiment, the at least one preselected operation includes copying any documents in the document data storage area to a selected destination, transferring any documents in the document data storage area to a selected destination, converting any documents in the document data storage area from a first selected file format to a selected second selected file format, performing optical character recognition on any image format documents in the document data storage area to convert the image format to text, assigning selected values to metadata fields within any documents in the document data storage area, and identifying criteria which must be associated with any documents in the document data storage area in order for preselected operations to be performed on documents. In operation, an associated user will be prompted for selected information required to perform the preselected operation and the selected information is received from the user via any suitable means.

In a preferred embodiment, an associated user is prompted to select a document data storage area for which the electronic documents are to be received and the user provides such selection via any suitable means. In a more preferred embodiment, the method further comprises the step of deselecting the designated document data storage area, wherein the at least one preselected operation is performed on all the electronic documents in the selected document data storage area until the designated data storage area is deselected.

In one embodiment, the method also comprises the steps of determining whether the at least one preselected operation is able to be performed, based on a positive determination, storing the at least one preselected operation in a memory device, and based on a negative determination, prompting an associated user to modify the at least one preselected operation.

In another embodiment, a plurality of preselected operations are associated with the document data storage area and wherein the preselected operations are performed in the order in which the preselected operations were associated with the document data storage area.

In yet another embodiment, at least one electronic document is received into each of a plurality of document data storage areas, wherein at least one preselected operation is associated with each document data storage area, and wherein the at least one preselected operation associated with each document data storage is performed on each document received into the associated data storage area.

Still further, in accordance with the present invention, there is provided a system for automatically performing preselected operations on electronic documents satisfying selected search criteria. The system comprises a memory adapted for defining therein a plurality of document data storage areas, each of the document data storage areas being adapted for storage of electronic documents and associating means adapted for associating at least one preselected operation with a document data storage area, such that such preselected operation is performed automatically by any electronic document received into the data storage area. The system also comprises receiving means adapted for receiving data representative of selected search criteria associated with electronic documents, means adapted for performing a search of the electronic documents in accordance with the search criteria, wherein the electronic documents obtained from the search are received in the document data storage area, and means adapted for performing the preselected operation on each electronic document received into the document data storage area.

In a preferred embodiment, the selected search criteria include at least one of keywords, indices, electronic document size, electronic document creation date, electronic document name, electronic document content, and electronic document creator name. Preferably, means adapted for receiving data representative of selected search criteria includes means adapted for prompting an associated user for information about the search criteria and means adapted for receiving from the associated user selection data representative of the search criteria after the completion of the step of prompting the user.

In a preferred embodiment, the at least one preselected operation includes copying any documents in the document data storage area to a selected destination, transferring any documents in the document data storage area to a selected destination, converting any documents in the document data storage area from a first selected file format to a selected second selected file format, performing optical character recognition on any image format documents in the document data storage area to convert the image format to text, assigning selected values to metadata fields within any documents in the document data storage area, and identifying criteria which must be associated with any documents in the document data storage area in order for preselected operations to be performed on documents. In operation, an associated user will be prompted for selected information required to perform the preselected operation and the selected information is received from the user via any suitable means.

In a preferred embodiment, an associated user is prompted to select a document data storage area for which the electronic documents are to be received and the user provides such selection via any suitable means. In a more preferred embodiment, the system further comprises means adapted for deselecting the designated document data storage area, wherein the at least one preselected operation is performed on all the electronic documents in the selected document data storage area until the designated data storage area is deselected.

In one embodiment, the system also comprises means adapted for determining whether the at least one preselected operation is able to be performed, based on a positive determination, storage means adapted for storing the at least one preselected operation in a memory device, and based on a negative determination, means adapted for prompting an associated user to modify the at least one preselected operation.

In another embodiment, a plurality of preselected operations are associated with the document data storage area and wherein the preselected operations are performed in the order in which the preselected operations were associated with the document data storage area.

In still another embodiment, at least one electronic document is received into each of a plurality of document data storage areas, wherein at least one preselected operation is associated with each document data storage area, and wherein the at least one preselected operation associated with each document data storage is performed on each document received into the associated data storage area.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain parts, and arrangements to parts, which are evidenced in conjunction with the associated drawings, which form a part hereof and not, for the purposes of limiting the same in which:

FIG. 1 illustrates an example of a network system for implementing the present invention.

FIG. 2 illustrates a hierarchical tree structure of a repository in a document management system.

FIG. 3 illustrates flowchart for automating selected operations to be performed on electronic documents according to the present invention.

### DETAILED DESCRIPTION OF THE PREFERRED EMBODIMENT

The document management system preferably provides access to a document management repository via a folder incorporated into the existing operating system file structure. Although the present invention is described as enabling users to access document management functionality from a Microsoft Windows operating system, it will be appreciated to those skilled in the art that the present invention is also suitably designed to interact with any operating system, such as Unix, Linux, Macintosh or other operating system. In one embodiment, the document management platform provides access to network-based documents via a browser, such as Internet Explorer or Netscape. In the presently preferred embodiment, a document repository managed by the document management platform is represented as a folder or data storage area within an Internet Explorer window. The document management platform permits a user to perform operations on the repository folder or data storage area, preferably insofar as the user has the appropriate access rights, as will be appreciated by those skilled in the art.

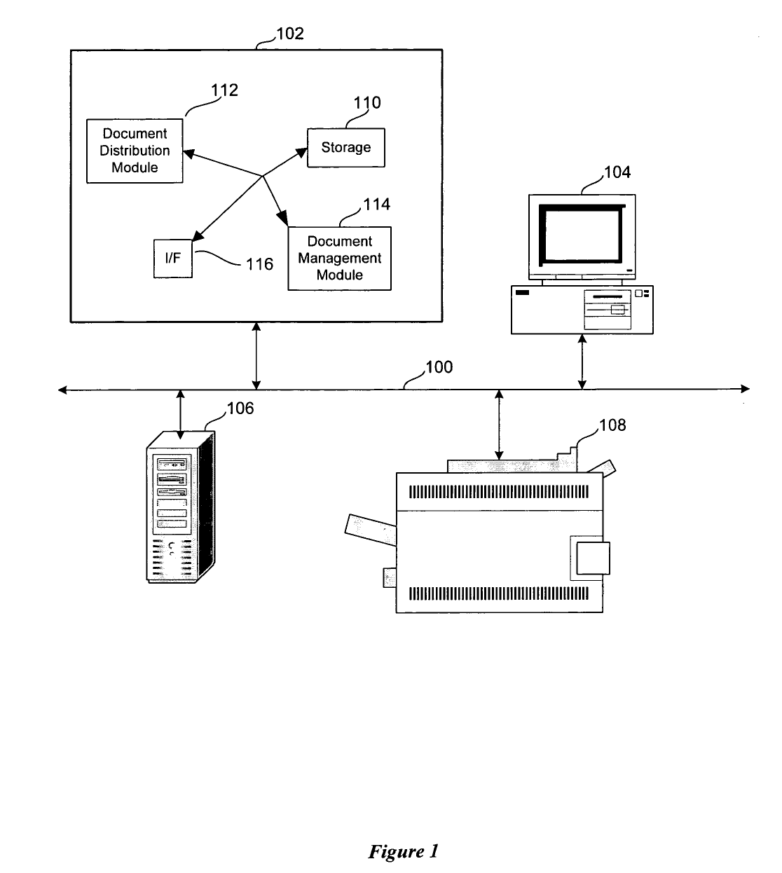

Referring now to FIG. 1, an illustration of a network environment for practicing the present invention is provided. The system comprises a data transport network 100 illustrative of a LAN or WAN environment in which a preferred embodiment is provided, such as a packet-switched TCP/IP-based global communication network. The network 100 is suitably any network and is preferably comprised of physical layers and transport layers, as illustrated by a myriad of conventional data transport mechanisms like Ethernet, Token-Ring™, 802.11(b), or other wire-based or wireless data communication mechanisms as will be apparent to one of ordinary skill in the art.

Connected to a data transport network 100 is a document management platform 102. In the presently preferred embodiment, the document management platform preferably is a plug-n-play device having a hardware component consisting of a closed-box server that is easy to install, configure and support, and software components, both of which will be described in greater detail hereinbelow. The document management platform is suitably operable to provide services to at least one computer 104, at least one image generating device 108, and/or at least one server 106 connected to network 100. It is suitably a document distribution solution with document management capabilities.

The document management platform 102 suitably replaces or supplements existing facsimile, print and electronic mail servers, and preferably offers a more efficient method of transmitting, tracking and storing business-to-business documents. The document management platform 102 is preferably a client/server system, which is suitably implemented in both single and collaborative corporate workgroups (although not limited to such environments) and designed to increase productivity and reduce costs by making document communications more simple and reliable. The document management platform 102 suitably provides functionality enabling users to share documents and conduct collaborative work between various workgroups. Also connected to data transport network 100 is computer 104. The computer 104 is suitably either a server or client running on any OS, such as Windows NT, Windows 2000, Windows XP, Unix, Linux, Macintosh or other operating system. In addition, the computer 104 is suitably a thick client or thin client, as will be appreciated by those skilled in the art. For example, LAN environment, the document management platform 102 provides services from a “thin” browser-based client. The disclosed document management platform architecture is suitably accommodating for a “thick client” driver-based computer 104 and for a “thin client” browser-based computer 104.

At least one image generating device 108 is connected to data transport network 100. The image generating device is suitably a device such as a printer, facsimile machine, scanning device, copier, multi-function peripheral, or other like peripheral devices. The image generating device 108 is suitably any networked image generating device as will be appreciated to one of ordinary skill in the art. The image generating device 108 preferably has an internal device controller suitably acting as a fully functional server with the necessary hardware and software that ensure proper operation of the image generating device as will be appreciated by those skilled in the art. In addition, the image generating device 108 preferably comprises internal storage, which is suitably a hard disk and random access memory as will be appreciated by those skilled in the art.

Optionally, a server 106 is also connected to data transport network. Because both the image generating device and the document management platform 102 suitably have server functionality, an additional server is not necessary to practice the present invention. However, corporate networks rarely have only one server, and often have more than two servers, wherein the servers may be configured to perform different tasks. The server 106 is suitably any fully functional server with the necessary hardware and software to ensure proper operation. The server 106 is suitably a data archiving, and the like, an electronic mail server, an application server, or any server configured for performing a function across a network.

The document management platform 102 preferably comprises a document distribution module 12 and a document management module 114. It should be noted that the document management platform 102 is not limited to these particular modules, and suitably comprises additional modules for device management. The main function of the document management module 114 is to store documents in a central document repository and to facilitate user capability to modify documents, collaborate during document editing, and search and locate stored documents. The main function of the document distribution module 112 is to route jobs to their destinations such as image generating devices, servers, computers, a document repository, etc.

The document management platform 102 also suitably comprises internal storage 110, in which at least one document repository or data storage area is suitably maintained. The document management platform 102 preferably interfaces with data transport network 100 via network interface 116. Thus, the document management platform 102, server 106, computer 104 and at least one image generating device 108 are in shared communication.

The computer 104 suitably represents either a thick client or and a thin client with general interfaces to the document management platform 102. The computer 104 interfaces with the document distribution module 112 for document distribution to selected devices. The document distribution module 112 suitably reports back to the computer 104 the status of the documents forwarded to the document distribution module 112 for distribution.

The document management module 114 works with the document distribution module 112 and its components to enable users to quickly store and retrieve documents from a central repository, which is preferably stored in storage 110 on the document management platform 102, but is also suitably stored on any storage device in communication with data transport network 100. The repository allows a user to share documents and conduct collaborative work between various workgroups.

When the document management module 114 receives a document in image form, such as it would from a facsimile or scanning device, it suitably routes the image to the repository for storage. The image can also be forwarded to the document distribution module 112 for further routing to an output device, e.g., a printer. In addition, the image file is also suitably routed to other document management systems of a remote appliance over the network, and preferably ODMA compliant. A document received via electronic mail device is suitably processed as text or an attachment to a message and forwarded to the document management module 114. Both an image and a processed electronic mail document can be routed to the printer, repository, and other document management platform, and/or other output devices via the document distribution module 112.

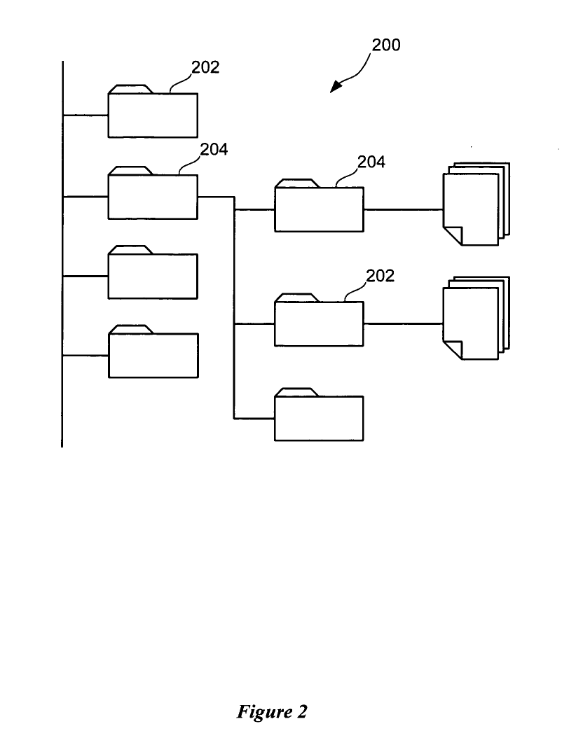

Referring now to FIG. 2, there is illustrated a hierarchical folder tree structure of a repository according to the present invention. The repository 200 is suitably comprised of a plurality of file folders or data storage areas. Users can browse through the repository 200 to access file folders and documents through a suitable user interface, preferably a graphical user interface as will be appreciated by one of ordinary skill in the art. Authorized users suitably create a hierarchical tree by creating new file folders and documents. Each file folder suitably contains both file subfolders and documents. A user is presented with file folders of two types: a private folder 202 and a group folder 204. The private folder 202 allows only the folder owner access this type of file folder. The folder owner has all rights on the objects contained in it. The private folder 202 is suitably created when an Administrator creates the user account. The group folder 204 is visible to users belonging to the group(s) assigned to this file folder. The operations that a user can perform on objects contained in the group folder 204 are limited to the access rights inherited from the respective group.

In one embodiment, the document management system of the present invention also includes an inbox repository or storage area to post incoming scanned image data, facsimiles, printed data, and the like. Such storages areas are suitably personal storage areas for each user or group or shared storage areas. The scanned images, facsimiles, printed data, and the like are posted to such storage areas based on the parameters provided by the user.

The document management system of the present invention allows a user to automate selected operations to be performed on at least one document satisfying selected search criteria and located in a selected document data storage area. In operation, the user selects at least one operation to be performed on documents in a document data storage area. The user is provided the capability to select or define one or more operations to be performed. The user is then provided the opportunity to save the selected operations in a file or script. The user then associates the script with a selected document data storage area. The user then defines or selects the desired search terms or criteria for locating documents on which the selected operations are to be performed. A search is then performed using the defined search criteria and documents satisfying such criteria are located and received into the selected document data storage area. The documents received in the document data storage area will be automatically processed according to the operations specified in the associated script. Preferably, only one script is associated with a document data storage area may be selected for each user. Preferably, more than one document data storage area is associated with one script. Preferably, the operations are performed in sequential order corresponding to the order in which the operations were associated with the data storage area. Preferably, scripts are able to be edited, renamed, deleted, and shared between users in any suitable manner known in the art.

Preferably, the document data storage area is selected from a private folder, a group folder, and an electronic inbox.

In one embodiment, the document management system also includes means adapted for deselecting the designated document data storage area so that the selected operations are no longer performed on documents in the document data storage area. Until the user deselects the designated document data storage area, all selected operations are performed on documents received into the designated document data storage area. At this point, the user elects to stop the process or select another document data storage area for which selected operations are to be performed.

In another embodiment, the document management system includes means adapted for determining whether the selected operations or script are able to be executed. If the determination is positive, the selected operations are stored in any suitable memory device . If the determination is negative, the user is prompted to edit or revise the script. The revised script is then reviewed to determine if the selected operations are able to be executed.

In another embodiment, the document management system provides a plurality of document data storage areas. In this embodiment, at least one document is received into each document data storage area. At least one operation is associated with each document data storage area and the at least one operation associated with each document data storage area is performed on each document received into the associated document data storage area.

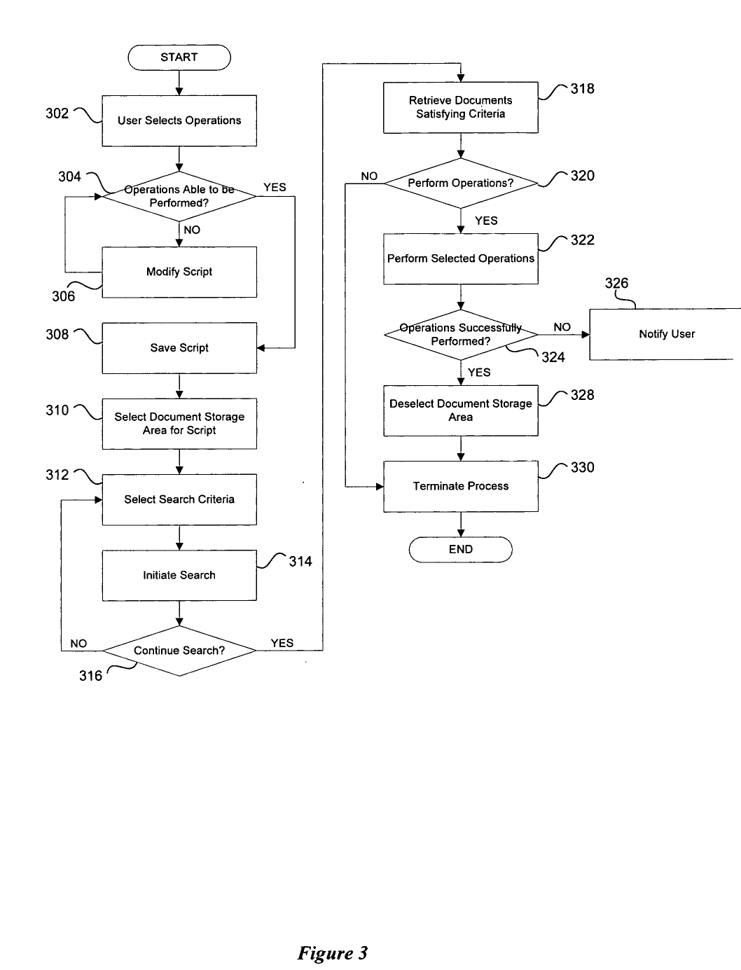

Referring now to FIG. 3, there is illustrated a flow chart of the process for performing at least one selected operation on documents received in a selected document data storage area according to the present invention. Flow commences at process block 302 wherein the user selects at least one operation to be performed on documents in a document data storage area. The user is provided the capability to select or define one or more operations to be performed.

The selected operations which may be performed on documents in the storage area include, but are not limited to, copying any documents in the data storage area to a selected destination (Copy To), transferring any documents in the data storage area to a selected destination (Move To), converting any documents in the data storage area from a first selected file format to a selected second selected file format (Convert To), performing optical character recognition on any image format documents in the data storage area to convert image format documents to text format (OCR), assigning selected values to metadata fields any documents in the data storage area (Set Metadata), and identifying criteria which must be associated any documents in the data storage area in order for selected operations to be performed on documents (Filter By).

The Copy To operation copies the documents received in the selected data storage area to a specified destination identified by the user. To identify the destination, the user provides selected information about the specified destination in any suitable manner known in the art. Suitable destinations, include, but are not limited to, image generating devices, electronic mail servers, Internet servers, and document management repository. The selected information about the destination is stored in a routing profile record in the document management system.

The Move To operation is similar to the Copy To operation, except that the documents received in the selected data storage area are moved or transferred to a specified destination. To identify the destination, the user provides selected information about the specified destination in any suitable manner known in the art. Suitable destinations, include, but are not limited to, image generating devices, electronic mail servers, Internet servers, and document management repository. The selected information about the destination is stored in a routing profile record in the document management system.

In the Convert To operation, the documents received into the selected data storage area are converted from a first selected file format to a second selected file format. To select the appropriate formats, the user provides information about the formats in any suitable manner known in the art. Preferably, the documents are able to be converted from PS to PDF, from PDF to PS, from PS to txt, from PDF to txt, from PS to TIFF, from PS to JPG, and from PS to BMP. Other types of document conversion, including any digital graphical storage format, are suitably utilized as will be appreciated by one of ordinary skill in the art.

The OCR operation extracts text from image format documents received into the selected data storage area, performs optical character recognition on such documents, and converts them to a text. Suitable image formats include, but are not limited to, PNG, JPG, BMP, and TIFF.

In the Set Metadata operation, selected values are assigned to metadata fields within documents in the data storage area. To select the values for the metadata fields, the user provides selected information in any suitable manner known in the art. The metadata information is stored in a file located in the document management repository.

In the Filter By operation, certain criteria is identified and documents in the data storage area must meet such criteria in order for operations to be performed on the documents. For example, the user can specify that only electronic mail documents will have selected operations performed on the documents. The user provides the selected criteria by any suitable manner known in the art.

Flow then continues to decision block 304 wherein a determination is made as whether the selected operations are able to be performed. If the determination is negative, the user is prompted to modify the file or script as shown at process block 306. The script is an ordered sequence of selected operations. The revised script is also analyzed to determine if the selected operations are able to be performed. If the determination is positive that the original script or the revised script is valid, flow continues to process block 308 wherein the user saves the selected operations in a script.

Flow then proceeds to process block 310 wherein the user selects a document data storage area for which the script is to be associated. The user identifies the appropriate data storage area by providing selected information about the data storage area in any suitable manner known in the art. Such information includes, but is not limited to, data storage area location, data storage area name, access permission, user name associated with the data storage area, and user name password. The user is suitably either a system user or a guest account. If the user is not currently authorized to access the data storage area, the user is prompted to provide a username and password to gain access. User rights to the folder are suitably assigned by an administrator in accordance with the level of access provided to that particular user.

At 312, the user defines or selects the search criteria for locating documents on which the selected operations are to be performed. The search criteria is selected by any suitable means. The search criteria include at least one of keywords, indices, electronic document size, electronic document creation date, electronic document name, electronic document content, and electronic document creator name. At 314, the search is initiated using the defined search criteria.

At 316, a determination is made whether the user desires to continue the search operation. For example, a user may have selected search criteria which will result in retrieving too many documents. If the user does not want to continue with such search criteria, flow proceeds back to 312 wherein the user defines the search criteria again.

If the user desires to continue with the search criteria, flow proceeds to 318 wherein the search is performed using the search criteria and documents satisfying such criteria are located and received into the selected document data storage area.

Flow then continues to decision block 320 wherein a determination is made whether user desires to perform the selected operations on documents in the data storage area. A negative determination causes progression to flow to 330 wherein the process terminates

A positive determination at decision block 320 means that the user is attempting to perform the selected operations on documents in the data storage area. At this point, progression flows to process block 322 wherein the selected operations are performed on documents in the document data storage area.

Flow then commences to decision block 324 wherein a determination is made as whether the operations were successfully performed. If the determination is negative, the user is notified as shown in process block 326. At this point, the user may elect several options (not shown), such as modifying the script or stopping the process. If the determination is positive, flow then continues to process block 328 wherein the user deselects the selected document data storage area via any suitable means so that the selected operations are no longer performed on documents in the document data storage area. The user may deselect the document data storage area at any time. At this point, the user may select another data storage area to receive documents or stop the process as shown at 330.

Although system as described runs on a network appliance, it is appreciated that it can also run on other operating systems, for example, Linux (and other Unix operating systems), and operating system by Apple Computers. Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

1. A method for automatically performing preselected operations on electronic documents satisfying selected search criteria, comprising the steps of:
associating at least one preselected operation with a document data storage area, such that such preselected operation is performed automatically by any electronic document received into the data storage area;
receiving data representative of selected search criteria associated with electronic documents;
performing a search of the electronic documents in accordance with the search criteria, wherein the electronic documents obtained from the search are received in the document data storage area; and
performing the preselected operation on each electronic document received into the document data storage area.

2. The method according to claim 1 wherein the selected search criteria include at least one of keywords, indices, electronic document size, electronic document creation date, electronic document name, electronic document content, and electronic document creator name.

3. The method according to claim 1 wherein the step of receiving data representative of selected search criteria comprises the steps of:
prompting an associated user for information about the search criteria; and
receiving from the associated user selection data representative of the search criteria after the completion of the step of prompting the user.

4. The method according to claim 1 wherein the at least one preselected operation includes copying any documents in the document data storage area to a selected destination, transferring any documents in the document data storage area to a selected destination, converting any documents in the document data storage area from a first selected file format to a selected second selected file format, performing optical character recognition on any image format documents in the document data storage area to convert the image format to text, assigning selected values to metadata fields within any documents in the document data storage area, and identifying criteria which must be associated with any documents in the document data storage area in order for preselected operations to be performed on documents.

5. The method according to claim 4 wherein the method further comprises the steps of:
prompting an associated user for selected information required to perform the preselected operation; and
receiving from the associated user selected information required to perform the preselected operation after the completion of the step of prompting the user.

6. The method according to claim 4 wherein the at least one preselected operation includes at least one of copying documents in the data storage area to a selected destination and transferring documents in the data storage area to a selected destination and wherein the designated destination is selected from the group consisting of an image generating device, an electronic mail server, an Internet server, and a document management repository.

7. The method according to claim 4 wherein the at least one preselected operation includes converting documents in the data storage area from a first selected file format to a second selected file format, and wherein the designated file formats include PS, PDF, txt, TIFF, JPG, and BMP.

8. The method according to claim 1 further comprising the steps of:
prompting an associated user with, selected information about a document data storage area for which the electronic documents are to be received; and
receiving from the associated user selection data designating a user-selected data storage area after completion of the step of prompting the user.

9. The method according to claim 8 further comprising the step of deselecting the designated document data storage area, wherein the at least one preselected operation is performed on all the electronic documents in the selected document data storage area until the designated data storage area is deselected.

10. The method according to claim 1 further comprising the steps of:
determining whether the at least one preselected operation is able to be performed;
based on a positive determination, storing the at least one preselected operation in a memory device; and
based on a negative determination, prompting an associated user to modify the at least one preselected operation.

11. The method according to claim 1 wherein a plurality of preselected operations are associated with the document data storage area and wherein the preselected operations are performed in the order in which the preselected operations were associated with the document data storage area.

12. The method according to claim 1 wherein at least one electronic document is received into each of a plurality of document data storage areas, wherein at least one preselected operation is associated with each document data storage area, and wherein the at least one preselected operation associated with each document data storage is performed on each document received into the associated data storage area.

13. A system for automatically performing preselected operations on electronic documents satisfying selected search criteria comprising:
a memory adapted for defining therein a plurality of document data storage areas, each of the document data storage areas being adapted for storage of electronic documents;
associating means adapted for associating at least one preselected operation with a document data storage area, such that such preselected operation is performed automatically by any electronic document received into the data storage area;
receiving means adapted for receiving data representative of selected search criteria associated with electronic documents;
means adapted for performing a search of the electronic documents in accordance with the search criteria, wherein the electronic documents obtained from the search are received in the document data storage area; and
means adapted for performing the preselected operation on each electronic document received into the document data storage area.

14. The system according to claim 13 wherein the selected search criteria include at least one of keywords, indices, electronic document size, electronic document creation date, electronic document name, electronic document content, and electronic document creator name.

15. The system according to claim 13 wherein means adapted for receiving data representative of selected search criteria further comprises:
means adapted for prompting an associated user for information about the search criteria; and
means adapted for receiving from the associated user selection data representative of the search criteria after the completion of the step of prompting the user.

16. The system according to claim 13 wherein the at least one preselected operation includes copying any documents in the document data storage area to a selected destination, transferring any documents in the document data storage area to a selected destination, converting any documents in the document data storage area from a first selected file format to a selected second selected file format, performing optical character recognition on any image format documents in the document data storage area to convert the image format to text, assigning selected values to metadata fields within any documents in the document data storage area, and identifying criteria which must be associated with any documents in the document data storage area in order for preselected operations to be performed on documents.

17. The system according to claim 16 further comprising:
means adapted for prompting an associated user for selected information required to perform the preselected operation; and
means adapted for receiving from the associated user selected information required to perform the preselected operation after the completion of the step of prompting the user.

18. The system according to claim 16 wherein the at least one preselected operation includes at least one of copying documents in the data storage area to a selected destination and transferring documents in the data storage area to a selected destination and wherein the designated destination is selected from the group consisting of an image generating device, an electronic mail server, an Internet server, and a document management repository.

19. The system according to claim 16 wherein the at least one preselected operation includes converting documents in the data storage area from a first selected file format to a second selected file format, and wherein the designated file formats include PS, PDF, txt, TIFF, JPG, and BMP.

20. The system according to claim 13 further comprising:
means adapted for prompting an associated user with, selected information about a document data storage area for which the electronic documents are to be received; and
means adapted for receiving from the associated user selection data designating a user-selected data storage area after completion of the step of prompting the user.

21. The system according to claim 20 further comprising the step of deselecting the designated document data storage area, wherein the at least one preselected operation is performed on all the electronic documents in the selected document data storage area until the designated data storage area is deselected.

22. The system according to claim 13 further comprising:
means adapted for determining whether the at least one preselected operation is able to be performed;
based on a positive determination, storage means adapted for storing the at least one preselected operation in a memory device; and
based on a negative determination, means adapted for prompting an associated user to modify the at least one preselected operation.

23. The system according to claim 13 wherein a plurality of preselected operations are associated with the document data storage area and wherein the preselected operations are performed in the order in which the preselected operations were associated with the document data storage area.

24. The system according to claim 13 wherein at least one electronic document is received into each of a plurality of document data storage areas, wherein at least one preselected operation is associated with each document data storage area, and wherein the at least one preselected operation associated with each document data storage is performed on each document received into the associated data storage area.
